(19) United States
(12) Patent Application Publication
(10) Pub. No.: US 2015/0002107 A1
(43) Pub. Date: Jan. 1, 2015

(54) REDUCING CURRENT HARMONICS AT LIGHT LOADS

(71) Applicant: Hewlett-Packard Development Company, L.P., Fort Collins, CO (US)

(72) Inventors: Daniel Humphrey, Cypress, TX (US); Mohamed Amin Bemat, Cypress, TX (US)

(21) Appl. No.: 14/370,758

(22) PCT Filed: Jan. 31, 2012
(86) PCT No.: PCT/US2012/023239

§ 371 Date: Jul. 3, 2014

(51) Int. Cl. H02M 1/12; H02M 1/42; H02M 3/156

(52) U.S. Cl. CPC H02M 1/12; H02M 3/156; H02M 1/4208
USPC 323/205; 323/284; 323/235

(57) ABSTRACT

Reducing current harmonics at light loads is disclosed. In an example, a method includes increasing output voltage of a boost converter to reach a higher potential in a low power mode. After reaching the higher potential, the method includes dropping a set point for the output voltage.

### BACKGROUND

The power factor (PF) of an alternating current (AC) electric circuit is the ratio of real power to apparent power, and is expressed as a number between 0 and 1.0 (or as a percentage). Real power is the capacity of the circuit to perform work in a given time, and apparent power is the product of the root mean square (RMS) current and RMS voltage of the circuit.

It may be desirable to adjust the power factor of an electronics system (e.g., a server computer or collection of computing resources, such as a data center). Power factor correction (PFC) circuits are available that bring the power factor of an AC circuit closer to 1.0. PFC circuits operate by determining the PF and adjusting input current so that the current is in phase with the supply voltage.

Various operating conditions (e.g., a non-linear load, or the amount of energy stored in the load versus energy returned to the power source) can cause the apparent power to exceed the real power, increasing transmission power losses, stranding data center capacity and tripping protection device(s). These conditions may cause failures in an area of, or even an entire data center.

### BRIEF DESCRIPTION OF THE DRAWINGS

FIG. 1 is a high-level view of a data center which may implement a control method to reduce current harmonics at light loads.

FIG. 2 is a schematic diagram showing more detail of an example circuit shown in FIG. 1 which may implement the control method.

FIG. 3 is a signal plot of example voltage set-points which may be used when implementing the control method.

FIG. 4 is a flowchart of example high-level operations to reduce current harmonics at light loads.

FIGS. 5a-c are more flowcharts illustrating more detailed operations which may be implemented to reduce current harmonics at light loads.

### DETAILED DESCRIPTION

Scale-out customers seeking to maximize capital investments are adding more information technology (IT) equipment to theft data centers (e.g., servers and associated electronics such as storage and communications devices). While physical space may be available for these additions, power consumption may push traditional limits of the data center power infrastructure. Strained power infrastructure can introduce new issues with harmonics, which may have been masked by the over-sized power infrastructures used in the initial configuration of these data centers. Such issues may be particularly acute when handling light loads.

By way of illustration, light loads may trigger harmonic currents, some of which can be sufficiently large so as to trip protection devices and cause data center failures. While adding expensive power devices between the IT equipment and the utility company may help by masking the problem, such a solution can significantly increase the data center operating costs for each power supply.

Instead of adding power devices to the data center, a control circuit is disclosed which reduces current harmonics at light loads. Adding this new technology to the existing power supplies, e.g., for power factor correction, can be significantly more cost-effective than adding new power devices in the data center. In addition, the control circuit addresses the underlying issue instead of simply masking the problem.

In an example, the control circuit may be implemented in a circuit, such as a power factor correction (PFC) circuit, to reduce current harmonics at light loads for power factor correcting boost converters. The circuit may be provided for one or more power supply (e.g., in a data center). Although the circuit typically resides with a power factor correcting boost converter, it is possible to deconstruct a typical power supply and have the PFC boost front end power a plurality of DC/DC power supplies in servers.

The circuit implements a control method to reduce current harmonics at light loads. Before entering a low power mode, the controller may set the output voltage to a default value. The default value may be selected such that at least one half cycle worth of energy is stored at the output of the PFC boost converter in capacitance. That is, after dropping below a set point, the method waits for the next zero-crossing to occur before recharging, and thus one half cycle's worth of energy is maintained as a “buffer” while waiting for the next zero-crossing.

During operation, the circuit enters the low power mode when the output power drops below a threshold. In the low power mode, a controller increases output voltage of a boost converter to reach a higher potential, and then drops the set point for the output voltage. A rate of increasing the output voltage of the boost converter may be selected such that the output voltage reaches the higher potential in an integer number of input cycles. The rate may be selected such that the output voltage from the boost converter appears as a higher load on the power supply, and reduces input harmonic content during charging.

A switch may be provided to stagger recharging a power source (e.g., parallel capacitors in the boost converter) after reaching the higher potential. Switching stops after the output voltage drops to the set point, thereby reducing or altogether eliminating harmonic content from the boost converter. After the output voltage drops to the set point, the controller waits for a subsequent zero-cross of an input voltage before again ramping up the output voltage to the higher potential.

In addition to reducing harmonics at light loads, the techniques described herein may enable “hyper” scaled data centers to push the design limits of the underlying power infrastructure, while reducing or altogether eliminating the risk of harmonic currents and false tripping of protection devices.

Before continuing, it is noted that as used herein, the terms “includes” and “including” mean, but is not limited to, “includes” or “including” and “includes at least” or “including at least.” The term “based on” means “based on” and “based at least in part on.”

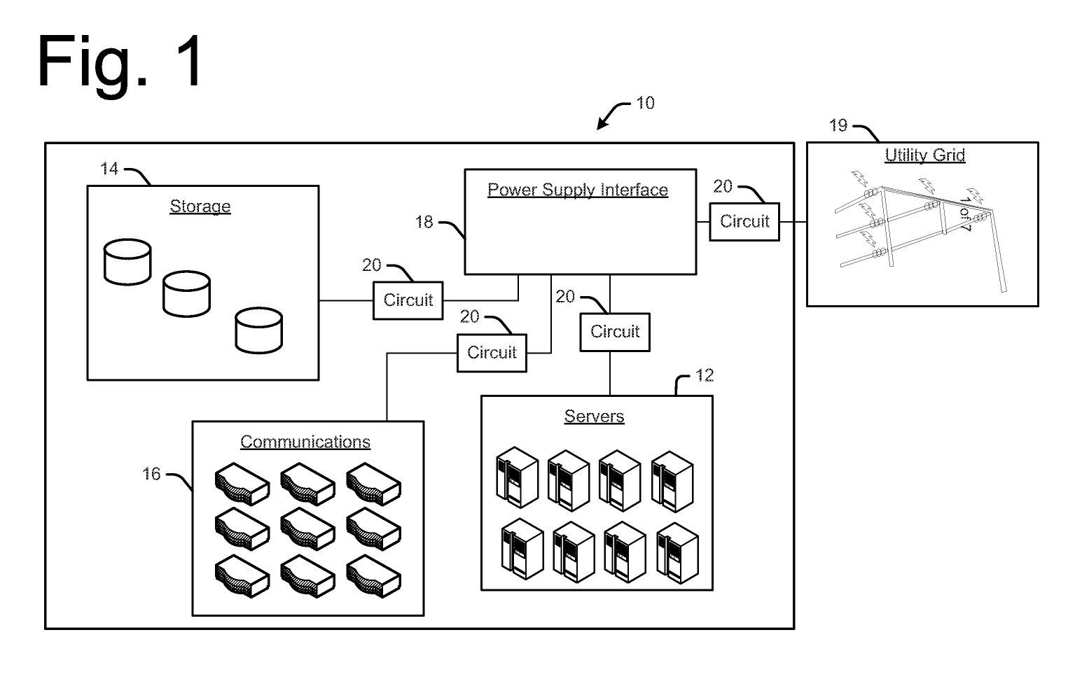

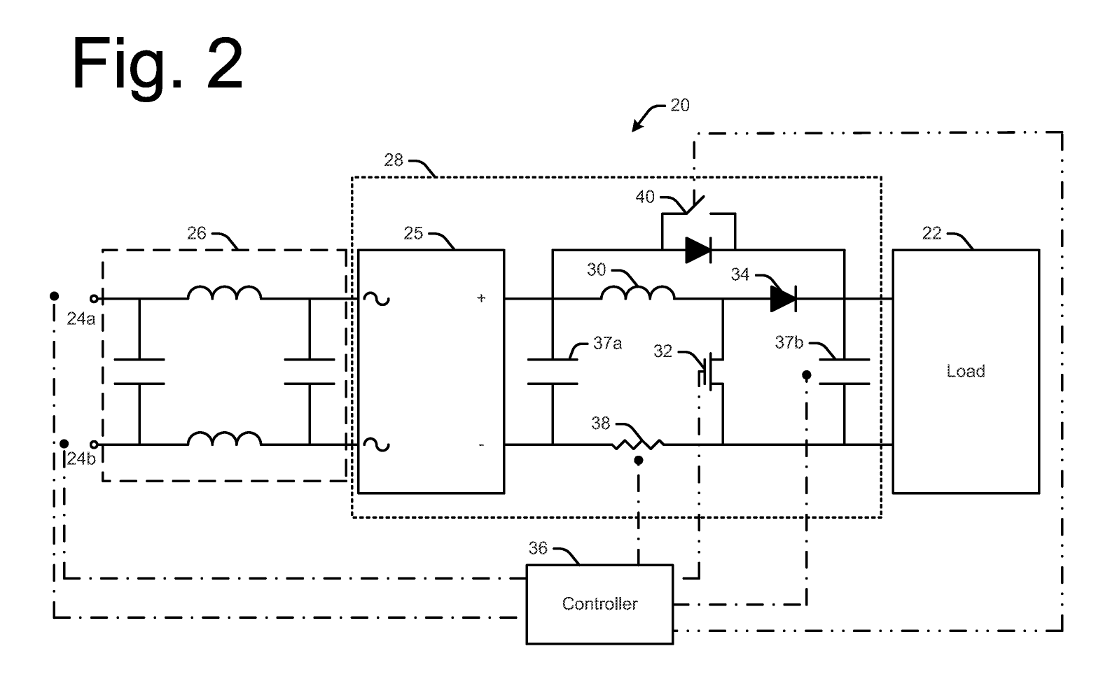

FIG. 1 is a high-level view of a data center 10 which may implement a control method to reduce current harmonics at light loads. The data center 10 may include any type and number of electronics devices. Racks of electronics devices are shown for purposes of illustration, and may include servers 12, data storage devices 14, and communications and network infrastructure 16.

The data center 10 may also include a power infrastructure, providing appropriate wiring and converters to deliver electrical power to the various data center components (e.g., servers 12, data storage devices 14, and communications and network infrastructure 16). The power infrastructure may also include an interface 18 to receive power from an external power source 19, such as the utility grid or external power generator. Intermediate power supplies (not shown) may also be provided on the power infrastructure, internally to the data center, for delivering electrical power within the data center 10.

In an example, the control method to reduce current harmonics at light loads is implemented in a circuit. The circuit 20 may be physically located such that the method is operable with the boost converter. For example, the circuit 20 may be provided between the external power source 19 and the power supply interface 18 as illustrated by circuit 20. In another example, the circuit may be provided elsewhere on the power infrastructure, as illustrated by circuits 20a-c.

The circuit 20 may be provided as part of an already existing PFC circuit (e.g., the PFC circuit may be modified with the control circuitry described herein), operate in conjunction with the PFC circuit, or be a stand-alone circuit.

PFC circuits control the current to match the voltage signal in order to approach or meet a power factor (PF) of 1.0. The PFC circuit 20 may correct current by monitoring the input voltage rectified waveform and force the input current to match the input voltage waveform. The PF can be determined based on voltage and/or current measurements. After correction there is much less difference between the current and voltage signals.

In an example, the PFC circuit takes the rectified input AC voltage (e.g., about 100-240 VAC) and boosts the input AC voltage (e.g., to about 400 VDC), referred to as “bulk voltage.” Further conversion is normally required to provide isolation and further regulation to the final load (e.g., 48V, 12V, or 5V). The energy stored in the bulk capacitor is typically sufficient to run the power supply for a minimum of about 10 ms at full output power, e.g., if AC power is lost, and much longer at light loads.

As mentioned above, strained power infrastructures can result from the creation of harmonic currents from PFC converters, some which can be large enough to trip protection devices and result in data center failures. The problem may be particularly acute for light loads. The circuit 20 may be used to reduce current harmonics at light loads, e.g., for power factor correction.

FIG. 2 is a schematic diagram showing more detail of an example circuit 20 shown in FIG. 1 which may implement the control method. In FIG. 2, the circuit 20 is implemented as part of a PFC circuit. Accordingly, the circuit 20 may be connected between a load 22 (e.g., electronic equipment in the data center) and an AC power source in the power infrastructure (not shown, but connected via leads 24a-b). A bridge 25 may provide a rectified AC signal which behaves as a “partial DC” signal. Bridges for providing a rectified AC signal are known in the electronics arts, and generally operate by “flipping” the negative portion of the AC sine wave so that it is the same polarity at the rectifier output as the positive portion of the AC sine wave. An inductive-capacitive circuit 26 may be provided as a high frequency filter element, e.g., an EMI filter.

The boost converter 28 provides a voltage “boost” of the voltage at the output of rectifier 25 to the load 22. An example boost converter 28 may include an inductor 30 controlled by a field-effect transistor (FET) 32 and diode 34. The boost converter 28 boosts the voltage supplied on the voltage bus. Capacitors 37a-b may be provided to hold the charge. Switch 40 charges capacitor 37a after the boost converter stops switching to prevent harmonic creating currents from peak charging of capacitor 37a. The return bus provides a path back to the AC power source.

Example circuit 20 is shown in FIG. 2 as it may be implemented in hard-wired circuitry. However, it is noted that the circuit 20 may also be implemented in other circuitry (e.g., logic gates) as will be readily apparent to those having ordinary skill in the art after becoming familiar with the teachings shown and described herein.

At light loads, various factors may impact harmonic content. Many of these factors may be addressed by increasing the load on the power supply. An example is the signal across current sense resistor 38. At light loads, there is little current and the signal has a very low signal to noise ratio. The signal is used to shape the current, and noise can show up as harmonic content. Another example is the slow response of the voltage control loop, which loosely regulates the output voltage powering load 22. At light loads, the output voltage increases very quickly, which may cause overshoot because the voltage control loop has a very slow response time. Accordingly, the boost converter 28 may stop switching at inconvenient times to prevent an over-voltage condition. But if the boost converter 28 is not switching, the boost converter 28 cannot power factor correct. This introduces irregularities during each cycle on the input line current which increases harmonic content.

Instead, the circuit 20 utilizes a controller 36 to implement two modes of operation, a first mode of operation for light load conditions, and a second mode of operation for heavier loads. During heavier loading, the operations in the first mode of operation are disabled, and the boost converter 28 is allowed to operate normally. In the low power mode, capacitance 37a-b stores energy beyond normal energy potential, and the boost converter 28 ceases to switch until the excess energy is depleted.

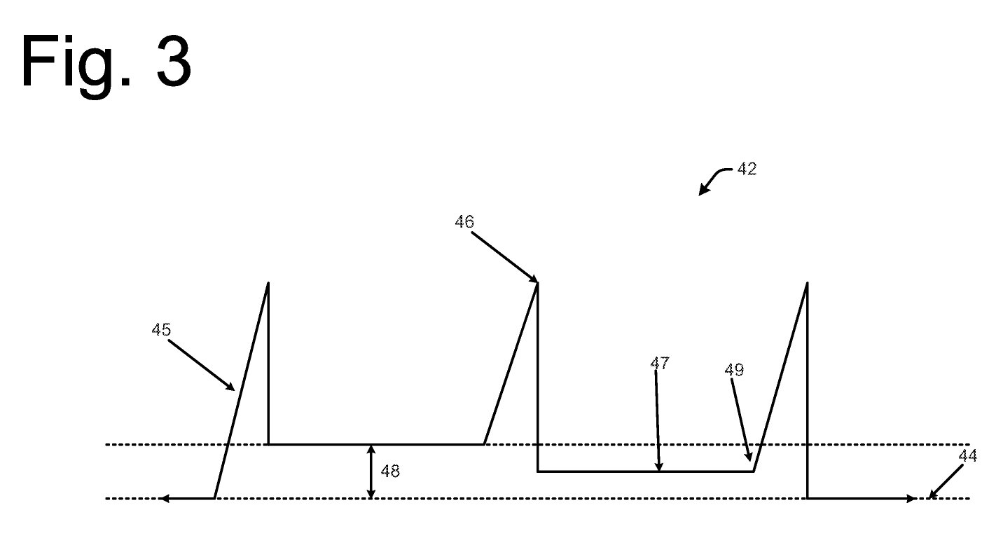

During operation, the controller 36 receives input based on conditions at leads 24a-b, current sense resistor 38, and stored energy in capacitors 37a-b. Based on load conditions, controller 36 controls the charging/discharging cycles of capacitors 37a-b via output to FET 32 and/or switch 40. It should be noted that switch 40 does not need to be installed unless capacitor 37a is large enough to negatively affect the power supply harmonics while the boost converter 28 is not switching. Controller 36 manipulates the set point of the boost converter 28, as explained in more detail below with reference to FIG. 3.

FIG. 3 is a signal plot 42 illustrating voltage set-points. The set points may be manipulated by the controller 36 described above with reference to FIG. 2. Prior to entering the low power mode, the voltage is set to a default value. Upon entering the low power mode, the controller 36 sets the output voltage to the level shown at 44.

At the next zero-crossing of the input voltage, the controller 36 increases the output voltage 45 of the boost converter 28 such that it reaches a higher potential, shown at point 46. It is noted that the voltage at set point 46 may be a range of voltages, to permit the controller 36 to provide a near constant input current during recharge.

The controller 36 may set the rate of increase such that the output voltage reaches voltage 46 in an integer number of input half cycles. This gives the appearance of a higher load on the power supply, and reduces input harmonic content during charging time.

After the voltage reaches the level indicated at set point 46, the controller drops the voltage set point to a lower value 47. In an example, the lower value 47 may be preprogrammed. In another example, the lower value 47 may be randomly selected from a range 48. Range 48 is shown having a minimum potential 44, and may be used to stagger the recharging between parallel power supplies and prevent overload conditions on the external circuits. The staggering can be random, or be set intelligently by a central manager (not shown). Range 48 may be provided such that it is sufficiently wide to provide options for multiple cycles.

After the output voltage reaches level 46, the controller 36 drops the set point to 47, and the boost converter 28 ceases switching. This reduces or altogether eliminates all harmonic content from the PFC converter.

The power supply may operate over multiple input cycles without switching until the voltage drops to set point 47. After the voltage drops to set point 47, the controller 36 waits until the next zero-cross of the input voltage, and then at 49 ramps up the output voltage again, to level 46′. This process may be repeated indefinitely until the load increases to a point which does not need to be operated in low power mode.

As an example, a 195 μF capacitor at 400 VDC can be charged with 15.6 J of energy. At 600 VDC, the same capacitance can be charged with 35.1 J of energy. At 50 W input, the power supply can operate from 600 VDC down to 400 VDC for 390 mS. This is approximately 19 to 23 cycles of input power depending on line frequency. If the power supply then uses 5 to 6 cycles to recharge the capacitor, the average power remains 50 W, but the average power during the time the converter is actually switching is about 250 W. This provides much better harmonic content than continuously operating at 50 W input, and appears as five times the load.

Before continuing, it is noted that the examples described above are provided for purposes of illustration, and are not intended to be limiting. The systems and methods do not need to be implemented in any particular circuit design. Other devices and configurations may also be utilized to carry out the operations described herein.

These modes of operation may be further understood with reference to the following flowcharts. The components and connections depicted in the figures described above may be used to implement the operations shown in the following flowcharts, and are referenced in the discussion below for purposes of illustration. Reference is also made below to the signal plot shown in FIG. 3. However, it is contemplated that the operations may be implemented in other circuitry, logic components, and/or control logic, such as a processor or processing units.

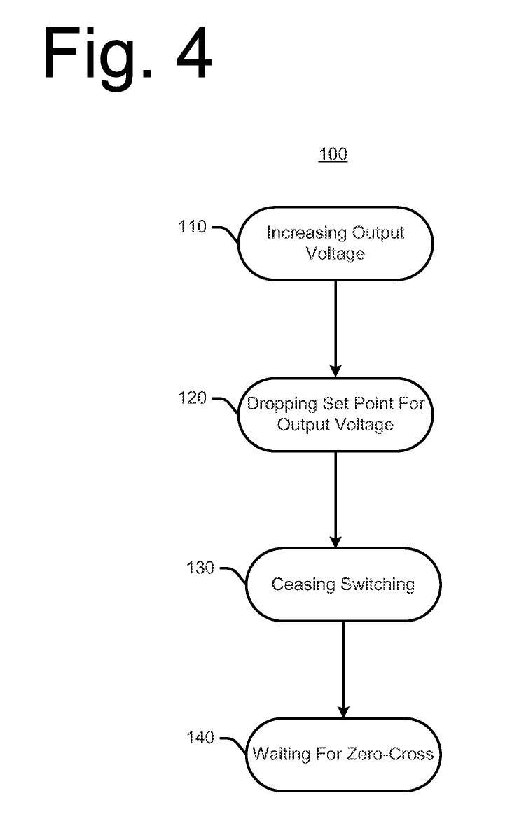

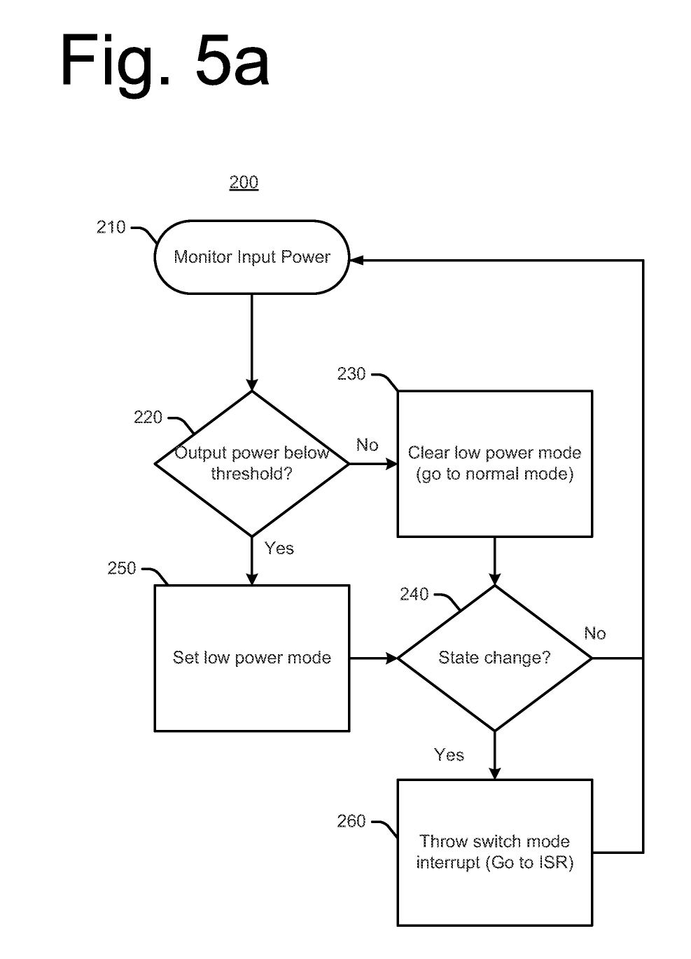

FIG. 4 is a flowchart 100 illustrating example high-level operations to reduce current harmonics at light loads for power factor correction. An example method includes entering a low power mode when the output power drops below a threshold. In the low power mode, the method includes (at 110) increasing output voltage of a boost converter 28 to reach a higher potential in a low power mode. The rate of increasing the output voltage of the boost converter 28 may be selected such that the output voltage reaches the higher potential 46 in an integer number of input half cycles. The rate of increasing the output voltage of the boost converter 28 appears as a higher load on the power supply, and reduces input harmonic content during charging.

After reaching the higher potential 46, the method includes (at 120) dropping to a set point 47 within a range 48 for the output voltage. This reduces or altogether prevents overload conditions on external circuits.

The method may also include (at 130) ceasing switching between recharging capacitors 37a-b after the output voltage drops to the set point 47 to reduce or eliminate harmonic content from the boost converter 28.

After the output voltage drops to the set point 47, the method may also include (at 140) waiting for a subsequent zero-cross of an input voltage before ramping up at 49 the output voltage to the higher potential 46′ again.

Although not shown in FIG. 4, the method may also include setting the output voltage to a default value before entering the low power mode.

The operations shown and described herein are provided to illustrate example implementations. It is noted that the operations are not limited to the ordering shown. Still other operations may also be implemented.

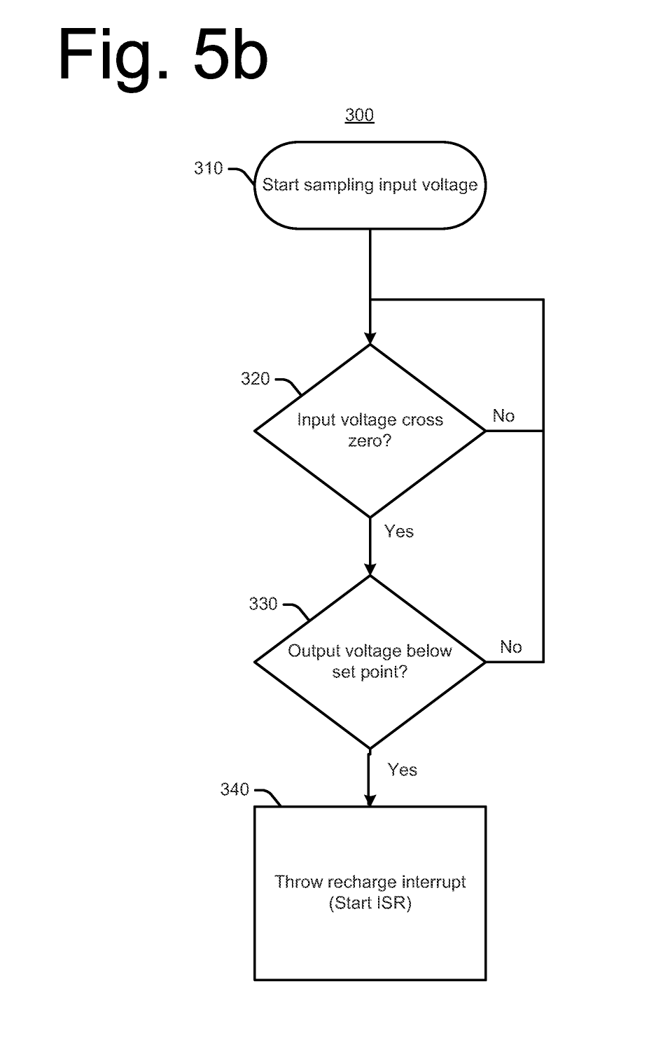

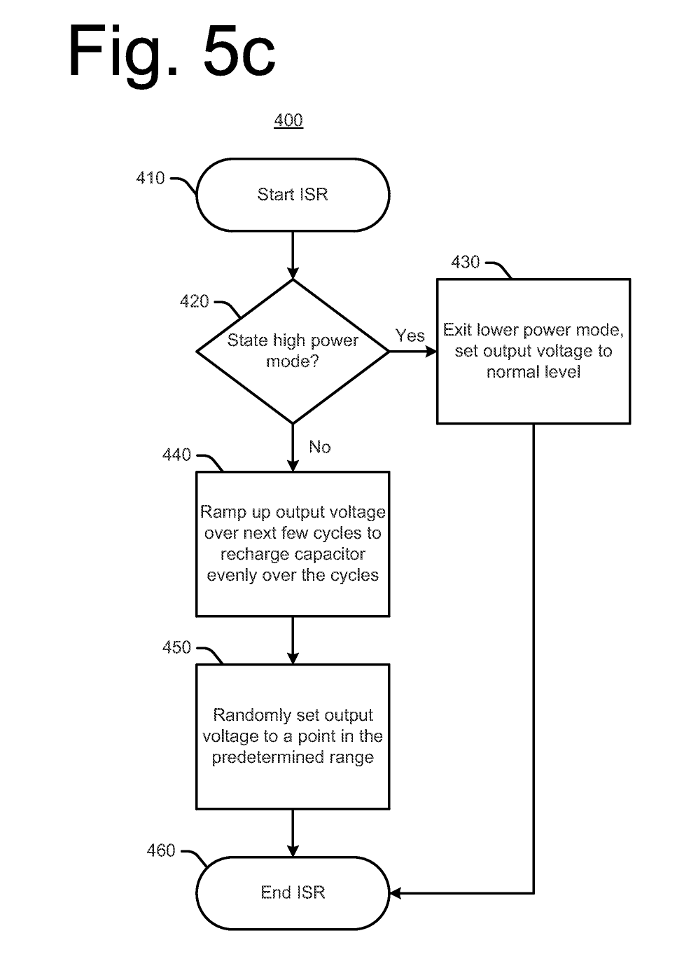

FIGS. 5a-c are flowcharts 200, 300, and 400 illustrating more detailed example operations to reduce current harmonics at light loads for power factor correction.

Flowcharts 200 and 300 in FIGS. 5a and 5b, respectively, illustrate monitoring operations, and the appropriate response to changes. Flowchart 200 represents operations for input power monitoring. Here, the input power is monitored at 210 and a determination 220 is made as to which of the modes the power supply should operate in (e.g., low power mode or high power mode). If input power is not below a threshold value at 220, then low power mode is cleared and no change is detected at operation 240, so normal operation proceeds in operation 210.

If input power is below the threshold value at 220, then the controller 36 sets low power mode in operation 250, a state change is detected in operation 240, and at 260 the routine triggers an interrupt and the interrupt service routine (ISR) addresses the change (described below for flowchart 400).

Flowchart 300 shown in FIG. 5b represents operations for input and output voltage detection. Operations start at 310 by sampling input voltage. If input voltage is at a zero crossing in operation 320, and the output voltage has dipped below the set point in operation 330, then an interrupt is triggered at 340. The ISR is instructed to recharge the output capacitor (described below for flowchart 400).

Flowchart 400 shown in FIG. 5c represents operations of the ISR. Operation 410 is triggered by either of the operations described above for flowchart 200 and/or flowchart 300. In operation 420, the ISR checks if the FTC circuit is operating in the high power mode or low power mode. If operating in high power mode, in operation 430 the controller sets the output voltage to the correct level and then terminates the routine at 460.

If operating in low power mode, then a zero cross has been detected and the output has fallen to a point where the capacitor needs to be recharged. Accordingly, the controller manipulates the voltage set point in operation 440 to charge the capacitor evenly over the next few cycles before switching stops again. The controller also sets an output voltage to 47 in operation 450, for example, randomly in a predetermined range 48.

It is noted that the examples shown and described are provided for purposes of illustration and are not intended to be limiting. Still other examples are also contemplated.

1. A method to reduce current harmonics at light loads, comprising:
increasing output voltage of a boost converter to reach a higher potential in a low power mode; and
after reaching the higher potential, dropping a set point for the output voltage.

2. The method of claim 1, further comprising stopping switching of the boost converter after the output voltage reaches the set point to eliminate all harmonic content from the boost converter.

3. The method of claim 1, further comprising after the output voltage drops to the set point, waiting for a subsequent zero-cross of an input voltage before ramping up the output voltage to the higher potential again.

4. The method of claim 1, further comprising setting the output voltage to a default value before entering the low power mode.

5. The method of claim 4, wherein the default value is selected such that at least one half cycle worth of energy is stored in capacitance at output of the boost converter.

6. The method of claim 5, wherein one half cycle worth of energy is maintained as a buffer while waiting for a subsequent zero-crossing.

7. The method of claim 1, wherein a rate of increasing the output voltage of the boost converter is selected such that the output voltage reaches the higher potential in an integer number of input half cycles.

8. The method of claim 7, wherein a rate of increasing the output voltage of the boost converter appears as a higher load on a power supply and reduces input harmonic content during charging.

9. The method of claim 1 further comprising entering the low power mode when the output power drops below a threshold.

10. A power factor correction circuit with current harmonics reduction at light loads, comprising:
a boost converter; and
a controller to increase output voltage of the boost converter to reach a higher potential in a low power mode, and then drop a set point for the output voltage after reaching the higher potential.

11. The circuit of claim 10, wherein the controller stops switching the boost converter after the output voltage reaches the higher potential to eliminate all harmonic content from the boost converter.

12. The circuit of claim 10, wherein the controller wafts for a subsequent zero cross of an input voltage before ramping up the output voltage to the higher potential after the output voltage drops to the set point.

13. The circuit of claim 12, wherein the controller increases the output voltage of the boost converter at a rate such that the output voltage reaches the higher potential in an integer number of input half cycles.

14. The circuit of claim 12, wherein the rate of increasing the output voltage of the boost converter is selected to appear as a higher load on a power supply.

15. The circuit of claim 12, wherein the rate of increasing the output voltage of the boost converter is selected to reduce input harmonic content during charging.
